(19) United States
(12) Patent Application Publication
(10) Pub. No.: US 2007/0103552 A1
(43) Pub. Date: May 10, 2007

(54) Systems and methods for disabling recording features of cameras

(75) Inventors: Shwetak N. Patel, Atlanta, GA (US); Gregory D. Abowd, Atlanta, GA (US); Khai N. Truong, Atlanta, GA (US); Jay W. Summet, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Georgia Tech Research Corporation

(21) Appl. No.: 11/271,204

(22) Filed: Nov. 10, 2005

(51) Int. Cl. H04N 3/08

(52) U.S. Cl. 348/203

(57) ABSTRACT

Systems and methods for controlling or effectively disabling recordation by a camera in an environment are disclosed. One system embodiment includes, among others, a detector and a neutralizer disposed in the environment and coupled to each other. One method embodiment, among others, includes emitting light or a signal into the environment, detecting a camera in the environment, and neutralizing the ability of the camera to capture an image with light emitted from a light source.

### TECHNICAL FIELD

The present disclosure is generally related to cameras and, more particularly, is related to systems and methods for controlling recordation by cameras.

### BACKGROUND

Camera phones, and related consumer technologies, make it easy to capture still and moving images anywhere, creating a legitimate concern among those who wish to retain some level of privacy or secrecy. Companies concerned that camera phones compromise the security of their intellectual property often ban such devices from their facilities. These confiscation practices, however, are not always desirable or practical. Although some legal controls and social boundaries may curb inappropriate capture behaviors, it would be desirable to safeguard against undesired recording without requiring confiscation by an authority or cooperation by the public at large.

Previous work addresses this challenge by disabling recording features in the cameras. Technical solutions have been proposed to prevent or to react to undesired camera capture. Most of these solutions require some sort of instrumentation in a capture device. For example, solutions, such as Safe Haven™, leverage the short-range wireless capability available on camera phones (such as Bluetooth or “WiFi”) to allow the environment to notify the device that the space does not allow photography or other forms of recording. There are many drawbacks to this solution, including that it assumes that the user of the camera would install and use special software on the device and that she would abide by the environmental constraints.

U.S. patent application Ser. No. 20040202382 discloses a wearable device that broadcasts an inhibit message to an area immediately surrounding a host wearer of the device. Any portable image capture devices, such as cameras or the like of third parties within range of the device receive the inhibit message, and in response to receiving the inhibit message, inhibit capture and/or apply processing of an image or part of an image. Again, this approach requires cooperation on the part of the image capture device. Other approaches also require different forms of cooperation on the part of the capture device or its operator. The “Cloak” system addresses privacy concerns with surveillance cameras by having users carry a “privacy enabling device” (PED). Brassil, J. Using Mobile Communications to Assert Privacy from Video Surveillance, 1st International Workshop on Security in Systems and Networks 2005, April 2005. This device informs the environment that any footage of the carrier of this device must be sanitized at a later time.

A solution called “Eagle Eye” couples a light sensor to a flash unit. Eagle Eye, Bulletin of the Connecticut Academy of Science and Engineering, Vol. 12, No. 2, 1997. When a flash of light is detected, this small wearable device instantaneously flashes back. This technique obscures a portion of the photographic image, somewhat similar to the approach described in this disclosure. Eagle Eye, however, only works against still, flash photography.

A need exists in the industry to address the aforementioned deficiencies and inadequacies.

### SUMMARY

Embodiments of the present invention provide systems and methods for controlling or effectively disabling recordation by cameras. Briefly described, one embodiment of the system, among others, can include the following: a detector disposed in the environment, the detector configured to detect the camera and including an emitter, and a lens; and a neutralizer disposed in the environment and coupled the detector, the neutralizer configured to neutralize an image captured by the camera.

The present invention can also be viewed as providing methods for inhibiting or effectively disabling recordation by cameras. In this regard, one embodiment of such a method, among others, can be broadly summarized by the following steps: emitting light or a signal into the environment, detecting a camera in the environment, and neutralizing the ability of the camera to capture an image with a second light emitted from a light source.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the disclosure and exemplary embodiments can be better understood with reference to the following drawings. The components in the drawings are not necessarily to scale, emphasis instead being placed upon clearly illustrating the principles discussed herein. Moreover, in the drawings, like reference numerals designate corresponding parts throughout the several views.

FIG. 1 is a block diagram illustrating one embodiment of a system for disabling or reducing the effectiveness of a camera.

FIG. 2 is a (a) top view and a (b) side view of an one embodiment of a system for disabling or reducing the effectiveness of a camera.

FIG. 3 is a block diagram illustrating one embodiment of a detector of the system of FIG. 1.

FIG. 4 includes (a) unfiltered and (b) filtered photographs of a retroreflective surface detected by a detector of FIG. 3.

FIG. 5 is a block diagram illustrating one embodiment of a detector of the system of FIG. 1.

FIG. 6 is a block diagram illustrating one embodiment of a neutralizer of the system of FIG. 1.

FIG. 7 is a block diagram illustrating one embodiment of a physical arrangement of the system of FIG. 1.

FIG. 8 is a flow chart illustrating one embodiment of a method for disabling or reducing the effectiveness of a camera.

### DETAILED DESCRIPTION

The present disclosure provides systems and methods for controlling or effectively disabling recordation by cameras, particularly in areas where camera recording is undesirable (e.g., art galleries, trade shows, research laboratories, manufacturing facilities, movie theaters, etc.). The disclosed systems use a combination of computer vision and projection to actively search for cameras and systematically block the cameras from recording clear pictures. The systems include a camera detector that actively tracks charge-coupled device (CCD) sensors and camera optical systems in the environment. When the systems detect a camera CCD sensor or optical system, a second system component, a camera neutralizer, directs a localized beam of light at each camera lens to obstruct the camera's view of the scene.

Reference is now made in detail to the description of certain embodiments as illustrated in the drawings. While several embodiments are described in connection with these drawings, there is no intent to limit the invention to the embodiment or embodiments disclosed herein. On the contrary, the intent is to cover various alternatives, modifications, and equivalents.

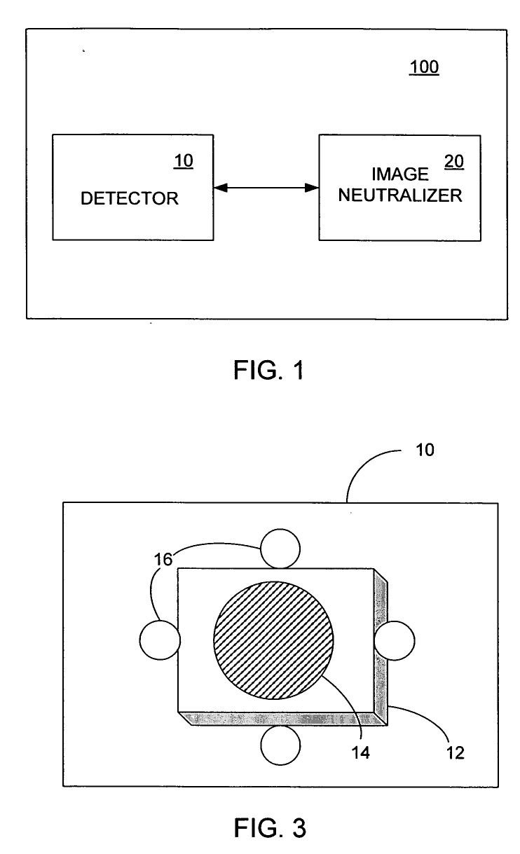

FIG. 1 illustrates an embodiment of a system 100 for effectively disabling recordation by cameras. The system 100 includes a detector 10 that is configured to detect a CCD sensor or optical system in an environment. The system 100 further includes an image neutralizer 20 that is communicatively coupled to the detector 10. The image neutralizer 20 includes a component that directs a visible light beam 70 to the camera with the CCD sensor that has been detected by the detector 10.

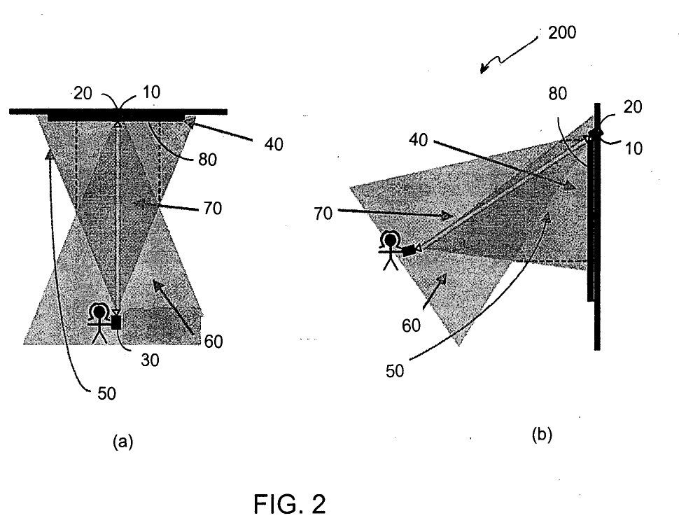

FIG. 2 illustrates another embodiment of a system 200 from (a) a top view and (b) a side view perspective. When a user introduces a camera 30 into the capture-resistant environment, the camera detector component 10 locates the camera 30 within its field of view and the camera neutralizer 20 emits the localized light beam 70 onto the camera 30 to block the camera's view of a portion of a surface 40 the system 200 attempts to guard from capture. The shaded triangular area 50 indicates the field of view of the user's camera 30. The shaded triangular area 60 indicates the camera neutralizer's field of influence. Dashed lines indicate the portion 80 of the protected surface 40 that is protected by the neutralizer light beam 70.

Detecting Cameras in the Environment

The detector 10 leverages the retroreflective property of the CCD sensor found on most consumer-level digital cameras. Both CCD- and complementary metal-oxide semiconductor (CMOS)-type cameras use semi-conductor based sensors. The disclosed system works against both types of sensors. This category of cameras will be referred to as “CCD cameras” or “CCD sensors” throughout the rest of the disclosure. Retroreflection causes light to reflect directly back to its source, independent of its incident angle.

CCD sensors are mounted at the focal plane of the camera's optical lens, making them very effective retroreflectors. Although many objects in the environment exhibit this property, they are typically imperfect retroreflectors and can be distinguished from CCD cameras by a sensor in the detector 10. By tracking bright retroreflections the detector 10 can detect and track cameras pointed at a given area.

One embodiment of the detector 10 is illustrated in FIG. 3. The detector 10 includes a video camera or “camcorder” 12. The video camera 12 includes a lens 14 that is designed to detect a retroreflective light. An example of a video camera 12 that can be utilized in the detector 10 is a Sony HANDYCAM® comprising a lens and a CCD imager and shutter. In one embodiment, the video camera can include a night recording system, such as for example, the Sony NIGHTSHOT® night recording system.

In the embodiment depicted in FIG. 3, the detector 10 includes light transmitters 16 disposed around the lens 14. The transmitters 16 can be disposed around the perimeter of the lens 14 in a configuration that generates a bright retroreflection from cameras to be detected (“detected cameras”) within the field of view of the lens 14. The exemplary embodiment in FIG. 3 depicts four transmitters 16 disposed approximately equidistant around the perimeter of the lens 14. Other numbers of transmitters 16 can be employed. For example, the number of transmitters can be 1 to 500. Other configurations of the transmitters 16 than that depicted can also be used. For example, in other embodiments the transmitters 16 are not equidistant from each other around the perimeter of the lens 14.

In one embodiment for detecting cameras in the environment, the system 100 includes a detector 10 that emits IR light at a wavelength of about 770 to about 880 nm. into the environment and uses the video camera 12 positioned to locate retroreflections of the IR light. The use of IR light as the light signal or light beam can be used in environments where visible light is not desirable (e.g., art galleries, movie theaters, etc.). When IR is used as the transmitted light frequency range, the detector lens 14 is fitted with a narrow bandpass IR filter. The detector 10 projects an IR light beam outwards from the transmitters 16 and detects any retroreflective surfaces within the field of view of the lens 14. The detected CCD cameras can be pointed directly at it or tilted away at slight angles from the detector 10. For example, the detected cameras can be pointed away from the detector at an angle up to about ±20°.

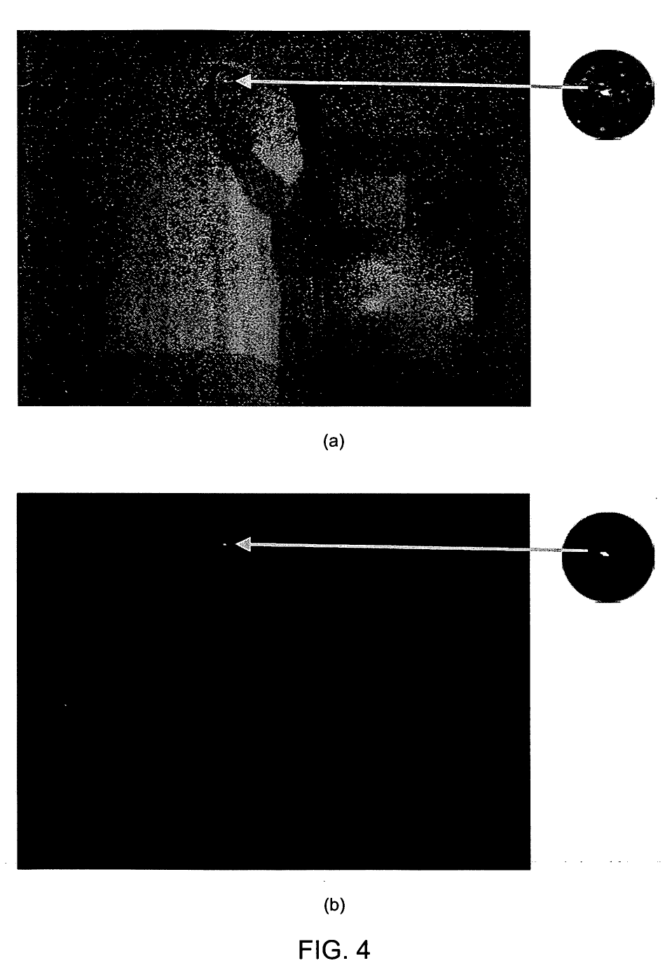

As shown in FIG. 4, the retroreflection of the detected cameras appears as a bright white circular speckle through the IR filtered camera. FIG. 4 depicts (a) an unprocessed IR view captured by the detector 10 with ample ambient light in the room. The camera phone depicted in FIG. 4 (a) is directed at a region in the environment that it is desired to protect from image capture by the camera phone. FIG. 4 also depicts (b) a processed view of the IR filtered lens 14.

In one embodiment for detecting cameras in the environment, the system 100 illuminates visible white light at a wavelength including the range 300 nm to 700 nm. This visible light will also be amplitude modulated (flashed) different from that exhibited by normal incandescent and fluorescent lighting into the environment and uses the video camera 12 to locate retroreflections of the white light. In this embodiment, the transmitters 16 are white LEDs transmitters disposed around the lens. In one embodiment, the LED transmitters are pulsed on and off at the transmitted frequency. Therefore, pulsing of the LED transmitters enables the detector 10 to identify retroreflections in the environment.

Regardless of whether the transmitters 16 transmit visible or IR light, retroreflections from one or more detected cameras are detected by locating bright regions in the image detected by the camera 12 above a certain luminance threshold (see, e.g., FIG. 4). By using a thresholding technique, there is no limit to the number of the cameras that can be detected within the field of view of the detector 10. Other objects in the environment may also exhibit a retroreflective property, e.g., the human retina. To prevent false positives, the system 100 can include software that detects facial features in a field of view of the lens 14. However, since human eyes and eye glasses are imperfect retroreflectors, a threshold can be set for the detector 10 that prevents the false positives and does not always require facial detection.

The detector 10 has approximately a 45° field of view. In one embodiment of the detector 10, reflections from cameras of varying shapes and sizes can be detected up to about 10 meters away. For example, in this embodiment, at about 5 meters away, the cross-section of the detector field of view is an area of about 4 m wide×3 m high. Although a zoom lens can be added to the video camera 12, 5 meters is typically sufficient for a reasonably-sized room. Room sizes and walls naturally prevent individuals from recording the protected area from afar. To ensure that the detector 10 can detect cameras from all angles, the angle at which users can approach the protected surface can be measured. Accordingly, the number of detector units desired to cover a given protected area can then be determined. In addition, the detector 10 can be stationary and mounted to a wall or surface in an environment to stabilize the detector 10.

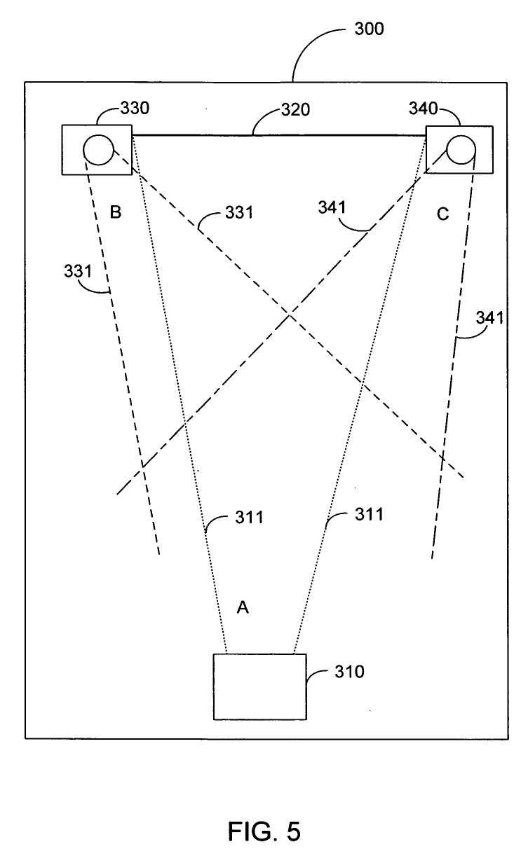

In the embodiment of a system 300 for effectively disabling recordation by cameras depicted in FIG. 5, the transmitter and lens are not disposed adjacent to each other. In the system 300, the transmitter 310 is located on one side of a room and projects light or an image in a field A defined by lines 311. The transmitter 310 can be, for example, a movie projector and the room can be, for example, a movie theater. The light or image projected in field A is reflected off a reflector 320. In one embodiment, the reflector 320 is a movie screen. The system 300 includes at least one lens, but we show two in this embodiment 330, 340 disposed on either side of the reflector 320. The first lens 330 has a first field of view B, defined by lines 331. The second lens 340 has a second field of view C, defined by lines 341. In the embodiment of a movie theater, the lenses 330, 340 are configured so that their fields of view cover the practical area in which a detected camera may be placed. The light from the transmitter 310 reflects off the reflector 320 and thus creates a retroreflective response in a camera in the field of reflector 320 that can be detected by the lenses 330, 340.

In an alternative embodiment of a movie theater, a video signal output from the transmitter 310 (e.g., the projector signal) can be modified with a particular pattern that is not detectable with the human eye. The lens 330 and/or 340 can then be configured with software that enables the lens to detect the pattern being retroreflected by a camera in the audience of the movie theater. As noted previously, by using a thresholding technique, there is no limit to the number of the cameras that can be detected within the system 300.

Neutralizing Cameras

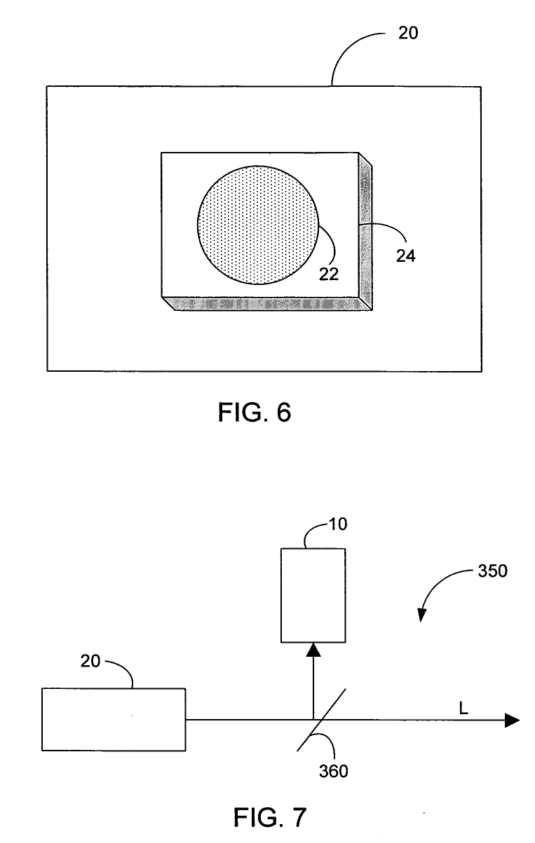

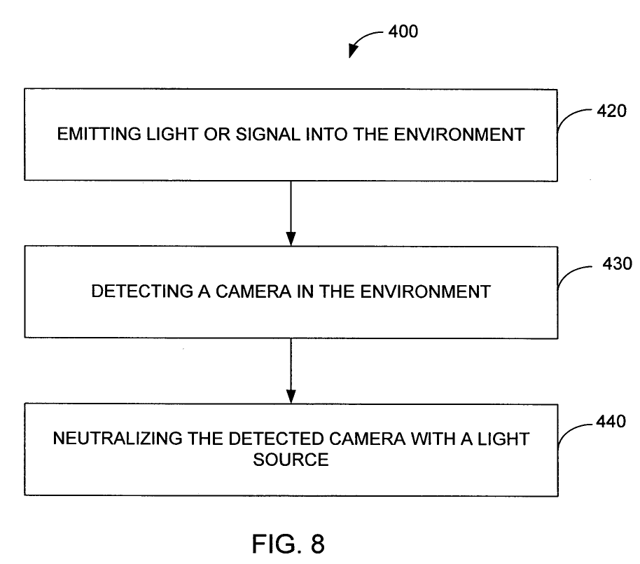

Once the camera detector detects a camera in the environment, it communicates information about the camera (e.g., the presence of a detected camera and/or its approximate or exact location) to the image neutralizer component 20. As illustrated in the embodiment of FIG. 6, the neutralizer 20 includes a light source 22 that emits localized light beams at each detected camera lens, resulting in a strong reduction in quality of the image captured by the detected camera. The light source 22, e.g., a concentrated light source, from the neutralizer 20 blocks the picture taken. In addition, the neutralizer 20 emits light beams in a variable pattern that prevents the detected CCD cameras from adjusting to the light and prevents the camera from taking an adequate picture. The light source 22 can be housed in or communicatively coupled to a controller 24 that communicates with the detector 10, and that controls the operation of the light source 22 (e.g., the timing, frequency, amplitude, pattern, wavelength, etc. of the light emitted from the light source 22).

The camera neutralizer 20 leverages the inherently imperfect sensing capabilities of typical CCD cameras that can result in, for example, at least one of three effects: over-exposure, blooming, and lens flare. The image captured by the detected camera can be over-exposed due to the light from the neutralizer 20, which results in an image that is saturated with light obscuring detail. Blooming can occur when a portion of the detected camera's sensor is exposed to excessive luminosity from a beam of light from the neutralizer 20, resulting in leakage to neighboring regions. For example, a candle in an otherwise dark setting may cause blobs or comet tails around the flame. Although some cameras are capable of compensating for these effects, typical cameras, e.g., those found on cellular phones, can only handle moderate amounts of light. Lens flare in the detected camera can be caused by the neutralizer 20 due to unwanted light reflecting and refracting off the glass and metal inside the camera. The size of the lens flare depends on the brightness of the light transmitted by the neutralizer 20. High-end cameras with well-designed and coated optics can minimize, but not completely eliminate, lens flare. By shining a beam of light at the detected camera lens, such as that emitted by a projector, blooming and lens flare can significantly prevent or inhibit any detected CCD camera from capturing the intended image. Digital cameras employ automatic exposure control algorithms that reduce blooming and flare. Typically, however, there is a delay before a sensor in the detected camera stabilizes. Thus, a flashing light from the neutralizer 20 prevents the detected camera from stabilizing itself with respect to the light source 22.

In one embodiment, the neutralizer 20 includes a projector as the light source 22. The projector can have a luminous flux of about 1500 to 50,000 lumens, or at least 1500 lumens. In one embodiment, the projector can emit a plurality of localized light beams of an area slightly larger than the size of the region covered by the detector 10. Pixels in the projected image can change between a plurality (e.g., two or more) of different colors, e.g., white, red, blue, green, and combinations thereof. Thus, detected cameras are prevented from adjusting to the light source 22 and the detected cameras are forced to take pictures flooded with light. In addition, the neutralizer 20 can vary the intensity of the colored light beams to prevent the detected cameras from automatically compensating, or being designed to automatically compensate, for specific color values. The neutralizer 20 can interleave various projection rates to neutralize a larger variety of detected cameras. The neutralizer 20 can continuously emit a light beam until the detected camera lens is no longer detected. The embodiment using the projector as the light source 22 acts against both still image and video cameras to inhibit, control, or reduce the quality of the capture of an image by the still and video cameras.

The projector can generate an effective localized light beam up to about five meters away. Although light from the projector can travel much farther, its luminance decreases with distance. Using the estimate of five meters as the length of a room, the projector can generate an effective localized light beam in the room. At five meters, projected localized light beams within a pyramidal region has a base of about 6 m in width×4.5 m in height. To ensure that the system can detect cameras from all angles, the angle at which users can approach the protected surface can be measured. Accordingly, the number of camera detector and camera neutralizer units desired to cover a given protected area can then be determined. Additional camera detectors can be mounted away from the surface to neutralize detected cameras from farther away if desired. In this embodiment, the camera neutralizers can be communicatively coupled to the detector(s) 10.

In one embodiment, instead of or in addition to a projector, the light source 22 is a pulsed laser beam deflected by a pair of spinning mirrors. A single laser source allows the neutralizer 20 to neutralize cameras with a single color. A plurality (e.g., two or more) of laser sources allows the neutralizer 20 to neutralize cameras in the same manner as a projector emitting a plurality of colors does, as described above. Whereas a projector solution can operate up to 85 frames per second, a laser beam can function at even faster frame rates. Thus, the laser can be pulsed so that the light is not visible when the laser moves between neutralized cameras and will cover the retroreflected area (e.g., the detected camera lens) enough times in a given second to effectively disable the lens from being able to accurately capture an image. The laser beam can be cheaper than a projector, and can be manufactured in a smaller form factor. An exemplary laser beam is a laser pointer device, or a diffused laser operating at less than 5 mW, or less than about 1 mW.

Coupling the Neutralizer with the Detector

It may be desirable to couple the neutralizer 20 with the detector 10. In one embodiment, the neutralizer 20 can be coupled with the detector 10 by placing two camera detectors 10 a known distance apart. By having two perspective of the same scene, depth information can be generated, in addition to the vertical and horizontal localization of the detected camera. In one embodiment, the neutralizer 20 can be coupled with the single detector 10 by a using a beam splitter 360. As illustrated in the coupled system 350 of FIG. 7, a beam splitter 360 is used to align the detector 10 and the focal point of the beam of light L from the neutralizer 20 coaxially. FIG. 7 illustrates but one exemplary layout of the beam splitter approach. The embodiment employing the beam splitter 360 can utilize smaller packaging. In larger spaces, however, the system embodiment employing dual cameras may be more desirable.

Permitting Camera Capture in the Environment

In one embodiment, users can be authorized to take pictures by turning off the disclosed systems for effectively disabling recordation by cameras. In one embodiment, two-dimensional retroreflective glyphs can be added to the disclosed systems to permit certain cameras to capture images within an environment, or of a protected surface, while blocking other cameras from operating within the environment as described above. The two-dimensional glyph encodes a unique identifier that allows the disabling system to recognize the detected camera to which the glyph is attached. The controller 24 of the neutralizer 20 can emit an electronic tag when it is desirable to allow a specific detected camera to capture an image within the protected space. In one embodiment, the glyph is mechanically attached to the detected camera adjacent the lens of the detected camera so that it can be seen by the detector 10. The disclosed systems can then allow the detected camera to take pictures in the environment by the controller directing the neutralizer 20 to not direct localized light beams at the permitted detected devices.

Disablement of Single Lens Reflex Cameras

A single lens reflex (SLR) camera includes a shutter over the CCD imaging area, thus preventing access by the detector 10 to the retroreflective area of the SLR camera. However, the SLR camera nevertheless leaves a different type of optical reflection signature. In order for a user of an SLR camera to view the intended image to be captured, incoming light beams are reflected in the camera up to a view finder, bypassing the shutter. Housed in the SLR camera body in front of the shutter is a mirror that directs light entering the camera body through the lens vertically upward at a 90° angle. Another mirror or pentaprism directs the light beams at a second 90° angle to a viewfinder in the camera. Thus, the first mirror in the SLR camera has a characteristic property of reflection that can be detected. In one embodiment of the detector 10, the detector is configured to detect this optical system, which indicates the presence of an SLR camera in the environment. The detector 10 can be configured to detect the SLR in place of, or in addition to, detecting retroreflective surfaces.

Methods of Effectively Disabling Recordation by Cameras

Included within the scope of the invention are methods of disabling or reducing the effectiveness of cameras within an environment. In this regards, one exemplary method 400 includes emitting light or a signal into the environment (420); detecting a camera in the environment (430); and neutralizing the ability of the camera to capture an image with light emitted from a light source (440). The emitting step can include emitting IR light, emitting visible light, emitting light that is reflected from a surface, or emitting a video signal, as described in more detail above. The detecting step can include detecting retroreflections from a CCD or CMOS camera, or detecting optical systems from a SLR camera or other imaging device. The neutralizing step can include neutralizing with a laser beam (e.g., monochromatic or multiple beams of different colors) or a pulsed light (monochromatic, or of varying colors).

Any process descriptions or blocks in the flow chart should be understood as representing modules that include one or more executable instructions for implementing steps in the process, and alternate implementations are included within the scope of the embodiment described here in which functions can be executed out of order from that shown or discussed, including substantially concurrently, depending on the functionality involved, as would be understood by those reasonably skilled in the art of the present invention.

It should be emphasized that the above-described embodiments are merely possible examples of implementations, and are merely set forth for a clear understanding of the principles of the invention. Many variations and modifications may be made to the above-described embodiment(s) without departing substantially from the spirit and principles of the invention. All such modifications and variations are intended to be included herein within the scope of this disclosure and the present invention and protected by the following claims.

At least the following is claimed:

1. A system for inhibiting or effectively disabling recordation by a camera in an environment, the system comprising:
a detector disposed in the environment, the detector configured to detect the camera and comprising
an emitter,
a lens, and
an image capturing device coupled to the lens; and
a neutralizer disposed in the environment and coupled to the detector, the neutralizer configured to neutralize an image captured by the camera.

2. The system of claim 1, further comprising a beam splitter located to coaxially align the detector and a focal point of a beam of light from the neutralizer.

3. The system of claim 1, wherein the emitter of the detector is chosen from at least one of the following: an IR light source, a visible light source, a reflection from a surface, or a video signal.

4. The system of claim 1, wherein the detector lens is housed in a video camera.

5. The system of claim 1, wherein the detector lens is housed in a video camera designed to detect the presence of at least one of the following: a retroreflective surface, reflection from an optical system, and combinations thereof.

6. The system of claim 1, wherein the detector lens is housed in a video camera that is adapted to detect the presence of at least one of the following: a charge-coupled device, a complementary metal-oxide semiconductor, a single lens reflex camera, and combinations thereof.

7. The system of claim 1, wherein the lens is covered with an IR narrow band pass filter.

8. The system of claim 1, wherein the neutralizer comprises:
a light source; and
a controller communicatively coupled to the light source and adapted to control the light source.

9. The system of claim 8, wherein the neutralizer light source is chosen from at least one of the following: a laser beam, a pulsed light beam.

10. The system of claim 8, wherein the neutralizer light source variably emits light of more than one wavelength.

11. The system of claim 1, wherein the system is housed in at least one of the following environments: a movie theater, a museum, an art show, a trade show, a manufacturing facility, and a furniture store.

12. The system of claim 1, wherein the detector is configured to detect a plurality of cameras in the environment.

13. The system of claim 1, wherein the neutralizer is configured and arranged to neutralize images captured by a plurality of cameras in the environment.

14. A method of disabling or reducing the effectiveness of camera within an environment comprising the steps of:
emitting light or a signal into the environment;
detecting a camera in the environment; and
neutralizing the ability of the camera to capture an image with a second light emitted from a light source.

15. The method of claim 14, further comprising a system for disabling or reducing the effectiveness of the camera within the environment, wherein the system comprises:
placing two detectors a known distance apart;
each detector detecting a perspective of a scene;
generating depth information about the scene; and
locating the detected camera in the environment based on the generated depth information.

16. The method of claim 14, further comprising the step of coaxially aligning a detector and a light beam emitted by a neutralizer with a beam splitter.

17. The method of claim 14, wherein the detecting step comprises at least one of the following: detecting retroreflections from a charge-coupled device (CCD) or complementary metal-oxide semiconductor (CMOS) camera, detecting the optical system of a SLR camera, and combinations thereof.

18. The method of claim 14, wherein the light source comprises at least one of the following: a laser beam, a pulsed light, and combinations thereof.

19. The method of claim 14, further comprising the step of permitting the detected to camera to capture an image by the detector recognizing a two-dimensional glyph code attached to the detected camera.

20. A system for controlling or effectively disabling recordation by a camera in an environment, the system comprising:
means for emitting light or a signal into the environment;
means for detecting a camera in the environment; and means for neutralizing the ability of the camera to capture an image with light emitted from a light source.
